(19) United States
(12) Patent Application Publication
(10) Pub. No.: US 2002/0093413 A1
(43) Pub. Date: Jul. 18, 2002

(54) Inductor, transformer and manufacturing method thereof

(76) Inventor: Ryu Shin'ei, Yokohama-shi (JP)

Correspondence Address: Ivan S Kavrukov, Cooper & Dunham, 1185 Avenue of the Americas, New York, NY, 10036, US

(21) Appl. No.: 09/563,279

(22) Filed: May 3, 2000

Related U.S. Application Data
(62) Division of application No. 09/268,529, filed on Mar. 12, 1999, now Pat. No. 6,147,584.
Application No. 09/268,529 is a division of application No. 08/405,176, filed on Mar. 16, 1995, now Pat. No. 5,939,966.

(30) Foreign Application Priority Data
Jun. 2, 1994 (JP) 6-121389

(51) Int. Cl. H01F 5/00

(52) U.S. Cl. 336/200

(57) ABSTRACT

An electric coil is formed of alternate strip parts and remaining strip parts. The alternate strip parts comprise alternate ones among a row of strip parts formed from a sheet of electrical conductor material, the row of strip parts forming a continuous electrical conductor having a form of a series of alternating reverse directional bends, a middle part of each strip part of the alternate strip parts being aligned with one another in a first line. The remaining strip parts comprise remaining ones among the row of strip parts, a middle part of each part of the remaining strip parts being aligned with one another in a second line separated from the first line. In manufacturing the electric coil, a forming member is used. The forming member has comb teeth, the comb teeth of the forming member being used to press and thus separate the middle part of each strip part of the alternate strip parts from the middle part of each strip part of the remaining strip parts.

### BACKGROUND OF THE INVENTION

1. Field of the Invention

The present invention relates to either a transformer such as a miniature power source transformer, or an electric coil, an inductance coil or an inductor (an electric coil, an inductance coil or an inductor being simply referred to as an inductor, hereinafter) such as an inductor for a miniature motor, and in particular, to a high frequency inductor and transformer with electric coils, each having a small winding turn number. Further, the present invention relates to either an inductor or a transformer or the like used in a switching power source used in various machines such as business machines such as electronic duplicators, facsimile machines, printing machines, personal computers, household electric machines, and industrial machines such as electric automobiles. In particular, the present invention relates to either an inductor or a transformer or the like used in a DC/DC power source unit which is used for stepping up or stepping down a voltage which has been obtained as a result of rectifying a power frequency voltage. Furthermore, the present invention relates to a transformer or the like used in a control circuit for controlling rotation of a motor, and to a inductor or the like used in a filter circuit for reducing noises.

### DESCRIPTION OF THE PRIOR ART

Conventionally, such an inductor or transformer is manufactured as a result of winding an electrical wire on a bobbin through a wire winding machine ordinarily. An EI core, a CI core or a barrel-type core is inserted into the bobbin having the electrical wire wound thereon.

In such a conventional inductor or transformer manufacturing process, steps of setting the bobbin on the wire winding machine, winding the electrical wire on the bobbin, and inserting the core into the bobbin require manpower. As a result, a manufacturing efficiency is not high and also manufacturing cost is high.

### SUMMARY OF THE INVENTION

An object of the present invention is to provide a inductor and a transformer which can be manufactured in a very easy process and automatically manufactured in a mass production manner. Both the inductor and the transformer have a structure such that a winding turn number thereof is adaptable on demand. Another object of the present invention is to provide a manufacturing method for manufacturing such an inductor or transformer in the same manner.

In order to achieve the above-mentioned object, an electric coil is provided, the electric coil comprising:

alternate strip parts comprising alternate ones among a row of strip parts formed from a sheet of electrical conductor material, the row of strip parts forming a continuous electrical conductor having a form of a series of alternating reverse directional bends, a middle part of each strip part of the alternate strip parts being aligned with one another in a first line; and

remaining strip parts comprising remaining ones among the row of strip parts, a middle part of each strip part of the remaining strip parts being aligned with one another in a second line separated from the first line;

A method for manufacturing the electric coil having the above-described structure comprises steps of:

a) processing a sheet of electrical conductor material to form the form having series of alternating reverse directional bends of a continuous electrical conductor, the continuous electrical conductor thus comprising a row of strip parts; and

b) moving a middle parts of each strip part of alternate strip parts among the row of strip parts so as to cause the middle part of each alternate strip part to be separate from a middle part of each strip part of remaining strip parts among the row of strip parts.

Thus, the electric coil can be easily formed.

In order to separate the middle parts of each strip part of the alternate strip parts from the middle parts of each strop part of the remaining strip parts, a forming member is used. The forming member has comb teeth, the comb teeth of the forming member being used to press and thus separate the middle part of each strip part of the alternate strip parts from the middle part of each strip part of the remaining strip parts.

The thus-used forming member may be either used as a bobbin of the coil or used as a jig and thus removed from the coil.

Further, in a case where an electric coil is mounted on a substrate and thus a circuit device is formed:

the middle part of each strip part of the alternate strip parts is separated from a surface of the substrate; and

remaining strip parts comprise remaining ones among the row of strip parts, a middle part of each strip part of the remaining strip parts being bonded onto the surface of the substrate.

When the coil is formed, the middle parts of each strip part of the remaining strip parts are bonded onto the surface of the substrate and also through holes are formed in the substrate. Then, the middle parts of each strip part of the alternate strip parts are pressed via the through holes. Thus, the middle parts of each strip part of the alternate strip can be easily separated from the middle parts of each strip part of the remaining strip parts. Further, by this method, the mounting of the electric coil onto the substrate can be performed at the same time the coil is formed. In other words, the coil forming work and the coil mounting work are performed in a single process.

It is possible to form a folded patterned wiring pattern member instead of the above-described folded patterned electrical conductor. In a case where the folded patterned electrical conductor is used, a turn of a coil is formed from a pair of adjacent strip parts. In a case where the folded patterned wiring pattern member is used, it is possible to form a plurality of turns of a coil from a pair of strip parts. This is because, in the folded patterned wiring pattern member, each strip part contains a plurality of lines of an electrical conductor as a form of a wiring pattern formed in the strip part.

As a result, it is possible to effectively increase a number of winding turns without increasing a number of times the folded pattern is folded back.

Other objects and further features of the present invention will become more apparent from the following detailed description when read in conjunction with the accompanying drawings.

### BRIEF DESCRIPTION OF THE DRAWINGS

FIG. 1 shows a plan view of insulated electrical conductive foils laid on each other used in a first embodiment of the present invention;

FIG. 2 shows a folded patterned foil member made from the foils shown in FIG. 1;

FIG. 3 shows a perspective view of forming members serving as a bobbin used in the first embodiment;

FIG. 4 shows a perspective view of an EI core used in the first embodiment;

FIG. 5 shows a perspective view of a state in which the folded patterned foil member is sandwiched by the forming members in the first embodiment;

FIG. 6 shows a perspective view of a state in which coils has been formed from the folded patterned foil member using the forming members in the first embodiment;

FIG. 7 shows a perspective view of the coils formed from the folded patterned foil member in the first embodiment;

FIG. 8 shows a perspective view of forming member made of ferrite used in a second embodiment of the present invention;

FIG. 9 shows a longitudinal sectional view of an assembly of either a transformer or an inductor in the second embodiment;

FIG. 10 shows a perspective view of a forming member serving as a jig used in a third embodiment;

FIG. 11 shows a longitudinal sectional view of either a transformer or an inductor in the third embodiment which is being assembled:

FIG. 12 shows a plan view of a folded patterned foil member used in a fourth embodiment of the present invention;

FIG. 13 shows a partial plan view of a printed circuit board used in the fourth embodiment;

FIG. 14 shows a plan view of an inductor in the fourth embodiment in which the folded patterned foil member has been bonded onto the printed circuit board;

FIG. 15 shows a cross sectional view of the inductor taken along a line XV-XV shown in FIG. 14 in which the coil has been formed from the folded patterned foil member;

FIG. 16 shows a longitudinal sectional view of the inductor taken along a line XVI-XVI shown in FIG. 14 in which a core has been integrated with the coil;

FIG. 17 shows a plan view of a printed circuit board used in a fifth embodiment of the present invention;

FIG. 18 shows a plan view of a state in which a folded patterned foil member has been bonded onto the printed circuit board;

FIG. 19 shows a plan view of a wiring pattern member used in an inductor in a sixth embodiment of the present invention;

FIG. 20 shows a perspective view of a pair of forming members used in the inductor in the sixth embodiment;

FIG. 21A shows a perspective view of a state in which the wiring pattern member has been sandwiched by the pair of forming members so as to form the inductor in the sixth embodiment;

FIG. 21B shows a perspective view of the wiring pattern member shown in FIG. 19 deformed to form a coil;

FIG. 21C shows a perspective view of the wiring pattern member and the pair of forming members shown in FIG. 21A in a state in which a top one of the pair of forming members has been removed after the deformation of the wiring pattern member;

FIG. 22 shows a perspective view of the inductor in the sixth embodiment;

FIG. 23A shows a plan view of an integrated body of a wiring pattern member and an electrical conductor foil member used in a transformer in the eighth embodiment of the present invention;

FIG. 23B shows a plan view of an integrated body of a first and second wiring pattern members used in a transformer in a first variant of the seventh embodiment of the present invention;

FIG. 23C shows a plan view of an integrated body of a wiring pattern member, an electrical conductor foil member, and either a second wiring pattern member of a second electrical conductor foil member used in a transformer in a second variant of the seventh embodiment of the present invention;

FIG. 24 shows a perspective view of a pair of forming members used in the transformer in the seventh embodiment;

FIG. 25 shows a state in which the integrate body shown in FIG. 23A has been sandwiched by the pair of forming members shown in FIG. 24;

FIG. 26 shows a perspective view of the integrated body shown in FIG. 23A deformed to form a coil; and

FIG. 27 shows a CI core used in the transformer in the seventh embodiment.

### DESCRIPTION OF PREFERRED EMBODIMENTS

With regard to FIGS. 1 through 4, a transformer and a transformer manufacturing method in a first embodiment of the present invention will now be described.

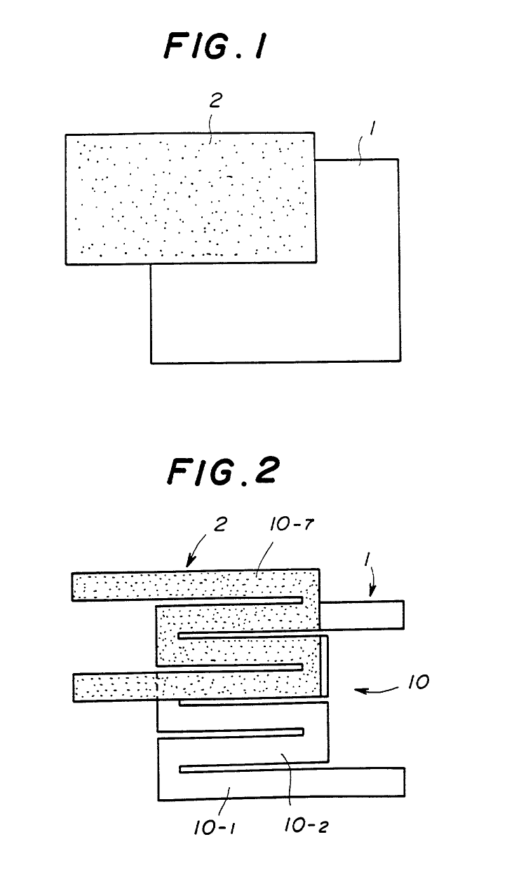

As shown in FIG. 1, two electrical conductor foils 1 and 2 are bonded together so that a part of a bottom surface of the foil 2 comes into contact with a part of a top surface of the foil 1. The thus-bonded foils will be referred to as a stack foil, hereinafter. Before the bonding, the entire surfaces of both of the foils 1 and 2 are electrical insulated. The stack foil is processed in a pressing processing manner so that a patterned foil member 10, shown in FIG. 2, is formed from the stack foil. As shown in the figure, the patterned foil member 10 has a shape as if it was formed as a result of folding back straightly extending strip parts many times. As shown in FIG. 2, the electrical conductor foil 1 of the foil member 10 has a shape as if it was formed as a result of folding back a strip part 5 times, and the electrical conductor foil 2 of the foil member 10 has a shape as if it was formed as a result of folding back a strip part 3 times. Such a patterned foil member is referred to as a folded patterned foil member and a shape such as that of the folded patterned foil member is referred to as a folded pattern, in the specification of the present application. With reference to FIG. 2, the folded patterned foil member 10 includes 7 parallelly arranged straightly extending strip parts starting from a strip part 10₋₁ and ending at a strip part 10₋₇.

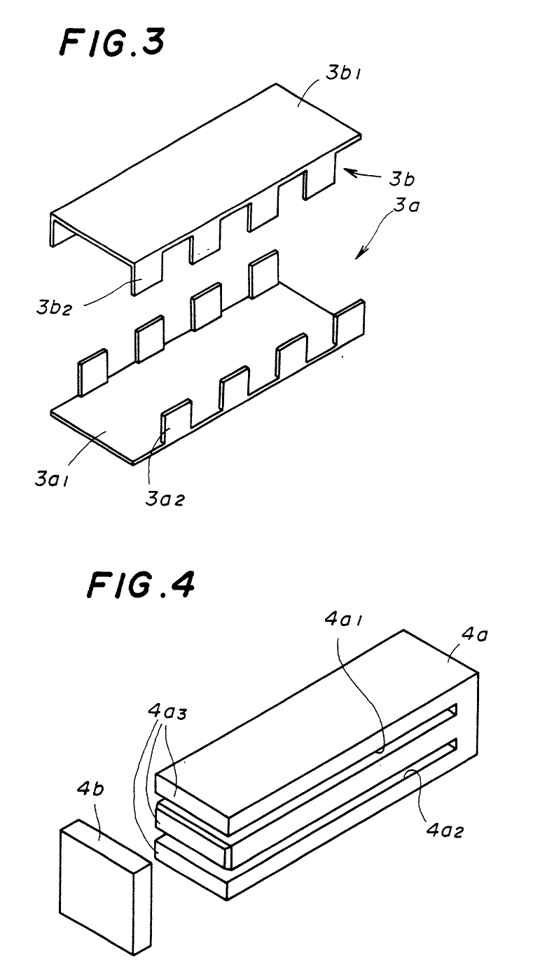

In addition to the folded patterned foil member 10, a pair of forming members 3a and 3b shown in FIG. 3 are also used for manufacturing the transformer in the first embodiment of the present invention. As shown in the figure, each of the pair of forming members 3a and 3b has a shape like an angular cornered letter “C” as seen in a cross sectional view thereof. The forming members 3a, 3b have 8 comb teeth 3a₂, 3b₂ at two sides of rectangular bodies 3a₁, 3b₁, respectively, the teeth extending perpendicular to the bodies. As described later, a shape of comb teeth 3a₂ and 3b₂ matches the arrangement of the above-mentioned 7 strip parts of the folded patterned foil member 10. Further, the pair of forming members 3a and 3b are formed such that when the pair of members 3a and 3b appropriately come into contact with each other, a tooth of one member of the pair of members 3a and 3b is fitted into a space between two adjacent teeth of the other member of the pair of members 3a and 3b.

Each member of the pair of members 3a and 3b is made from an insulating material such as plastic in this embodiment and acts as a bobbin of coils of the transformer.

Further, an EI core made from ferrite, shown in FIG. 4, is also used for manufacturing the transformer. As shown in FIG. 4, the EI core consists of a body 4a having a shape like the letter “E” as seen in a longitudinal sectional view thereof, and an end plate 4b having a shape like the letter “I” as seen in a sectional view thereof.

As the above-described EI core (4a and 4b) used in embodiments described in the specification, various types of cores can be used, such as, for example, an air-cored core, a magnetic core, and a dielectric core.

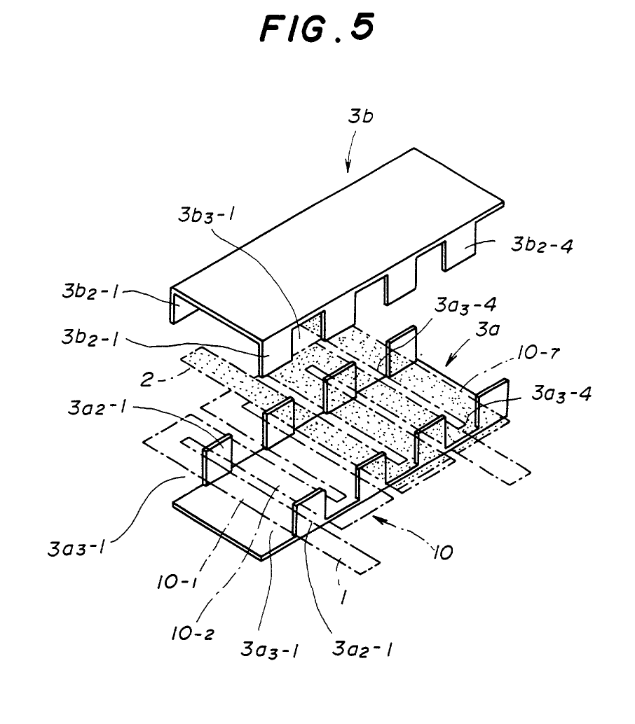

Then, as shown in FIG. 5, the folded patterned foil member 10 is placed on the forming member 3a. Thus, the strip part 10₋₂ of the folded patterned foil member 10 is placed on a left front pair of opposite teeth 3a₂₋₁ of the 8 teeth 3a₂. The end strip part 10₋₁ is placed on a pair of opposite spaces 3a₃₋₁, each of which spaces is located adjacent to a respective tooth of the left front pair of opposite teeth 3a₂₋₁. The strip part 10₋₇ of the folded patterned foil member 10 is placed on a pair of opposite spaces 3a₃₋₄, each of which spaces is locate between a right rear pair of opposite teeth and a pair of opposite teeth located adjacent to the right rear pair of opposite teeth of the 8 teeth 3a₂. Similarly, each strip part of the other 4 strip parts of the folded patterned foil member 10 is placed either on a respective one pair of the remaining two pairs of opposite teeth or, alternately, on a respective one pair of the remaining two pairs of opposite spaces.

Then, the forming member 3b is pressed to the bottom forming member 3a on which the folded patterned foil member 10 was placed as mentioned above. Thus, the top forming member 3b and the bottom forming member 3a together sandwich the folded patterned foil member 10. Thus, each tooth of a left front pair of opposite teeth 3b₂₋₁ of the top member 3b is fitted, via the left front strip part 10₋₁, into a respective one of the pair of opposite spaces 3a₃₋₁ of the bottom member 3a. Each tooth of the left front pair of opposite teeth 3a₂₋₁ of the bottom member 3a is fitted, via the subsequent strip part 10₋₂, into a respective one of the subsequent pair of spaces 3b₃₋₁ of the top member 3b. Each tooth of the right rear pair of opposite teeth 3b₂₋₄ of the top member 3b is fitted, via the right rear strip part 10₋₇, into a respective one of the pair of spaces 3a₃₋₄ of the bottom member 3a. Similarly, each pair of the remaining intermediate 4 pairs of teeth of the member 3a and 3b is fitted into a respective one of the remaining intermediate 4 pairs of spaces of the members 3a and 3b via the remaining 4 strip parts of the folded patterned foil member 10.

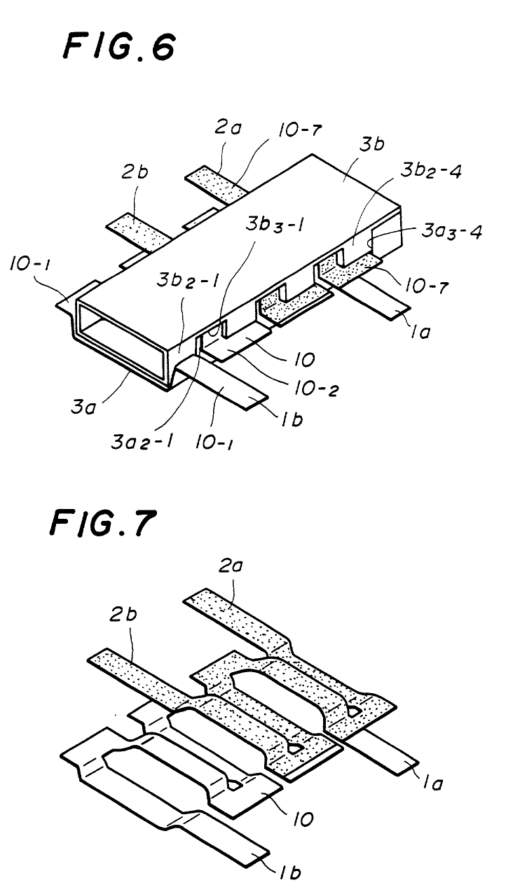

Thus, the top forming member 3b is pressed to the bottom forming member 3a until the extending edge of each tooth 3b₂ of the top member 3b comes into contact with the body 3a₁ of the bottom member 3a and the extending edge of each tooth 3a₂ of the bottom member 3a comes into contact with the body 3b₁ of the top member 3b. The folded patterned foil member 10 is deformed as a result of being pressed between the top and bottom forming members 3a and 3b. Thus, each of the 7 strip parts of the folded patterned foil member 10 is displaced by the extending edge of a respective one of the teeth 3a₂ and 3b₂ either upward or downward alternately. Then, after that, projecting portions of the folded patterned foil member 10 are folded as shown in FIG. 6. As a result of the forming members 3a and 3b together thus sandwiching and pressing the folded patterned foil member 10 therebetween as the teeth of the upper member 3a are engaged with those of the lower member 3b, the folded patterned foil member 10 is formed into a shape shown in FIG. 7. Thus, the folded patterned foil member 10 is formed to be coils in a thus-formed coil bobbin assembly of the forming members 3a, 3b and folded patterned foil member 10 is formed. The thus-formed coils consist of a first coil consisting of the electrical conductor foil 1 having 3 turns, and a second coil consisting of the electrical conductor foil 2 of the foil member 10 having 2 turns, as shown in FIG. 7.

In the above-mentioned coil bobbin assembly show in FIG. 6, the forming members 3a and 3b together act as the bobbin for the coil. Then, the coil bobbin assembly is integrated with the EI core 4a and 4b shown in FIG. 4. Thus, the body 3b₁ of the top forming member 3b is inserted in an upper gap 4a₁ of the body 4a of the EI core 4a and 4b. Similarly, the body 3a₁ of the bottom forming member 3a is inserted in an lower gap 4a₂ of a main body 4a of the EI core 4a and 4b. Then, the EI core 4a and 4b is fixed to the coil bobbin assembly 10, 3a and 3b using clamping metal fittings (not show in the figures), in which the end plate 4b of the EI core 4a and 4b is mounted onto the front left end surface 4a₃ of the body 4a of the EI core 4a and 4b. Thus, the transformer in the first embodiment of the present invention is formed. In the transformer, lead parts 2a and 2b of the second coil 2 having the smaller number of turns are used as primary input terminals and lead parts 1a and 1b of the first coil 1 having the larger number of turns are used as secondary input terminals. Thus, the transformer can be used as a step up transformer.

The present invention is not limited to the above-described two winding transformer in the first embodiment formed from the two layers of the insulated electrical conductor foils 1 and 2 of the foil member 10 shown in FIG. 2, in which the number of times of folding back in the foil 1 of the foil member 10 (5 times, as mentioned above) is different from the number of times of folding back in the foil 2 of the foil member 10 (3 times, as mentioned above). The present invention is also used to a transformer formed from a plurality of layers, other than two layers, of insulated electrical conductor foil members. For example, a three winding transformer is formed from three layers of insulated electrical conductor foil members, in which the numbers of times of folding back in the foil members are different from one another. Further, an inductor is formed from a single layer of insulated electrical conductor foil member, in which the foil is processed to be a shape as if a straightly extending strip part is folded back certain times.

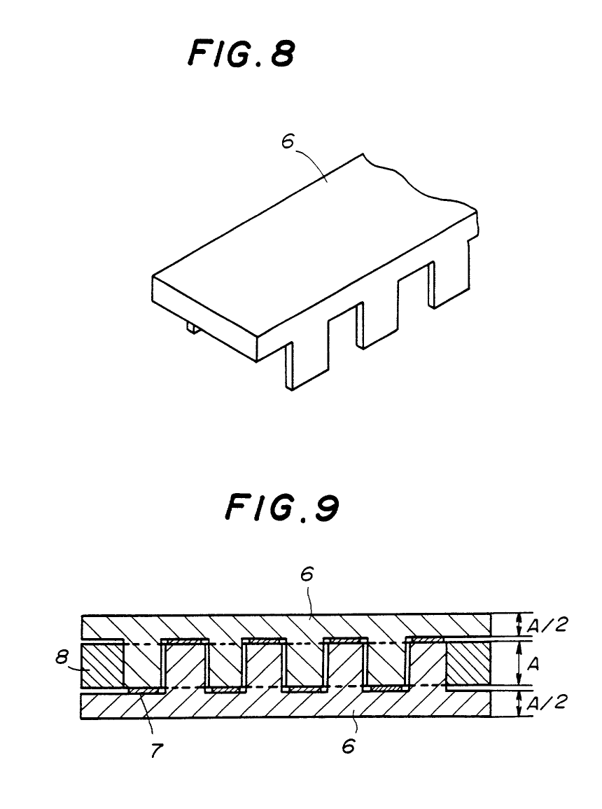

Further, the present invention is not limited to a transformer in which insulating material such as plastic made forming members such as the forming members 3a and 3b shown in FIG. 3 are used as a bobbin. Magnetic materials such as ferrite may be also used as materials of the forming members. Either a transformer or an inductor in a second embodiment of the present invention uses such ferrite made forming members. With reference to FIGS. 8 and 9, the transformer or inductor and a transformer or inductor manufacturing method in the second embodiment of the present invention will now be described. The transformer or inductor uses a pair of ferrite made forming members 6, each of which is shown in FIG. 8. In addition to the pair of forming members 6, the transformer or inductor in the second embodiment uses a folded patterned foil member 7 such as, for example, the folded patterned foil member 10 shown in FIG. 2. Then, similarly to the above-described coil bobbin assembly forming process of the transformer in the first embodiment, the pair of forming members 6 together sandwich and press the folded patterned foil member 7 therebetween as teeth of one member are engaged with those of the other member. Thus, a coil is formed from the folded patterned foil member 7. Then, an I-type core 8 is inserted between the thus assembled pair of forming members 6 and thus in the thus-formed coil 7. In the transformer or inductor, the ferrite bodies of the pair of forming members 6 act to form magnetic paths together with the I-type core 8.

As the above-described I-type core 8, various types of cores can be used, such as, for example, an air-cored core, a magnetic core, and a dielectric core.

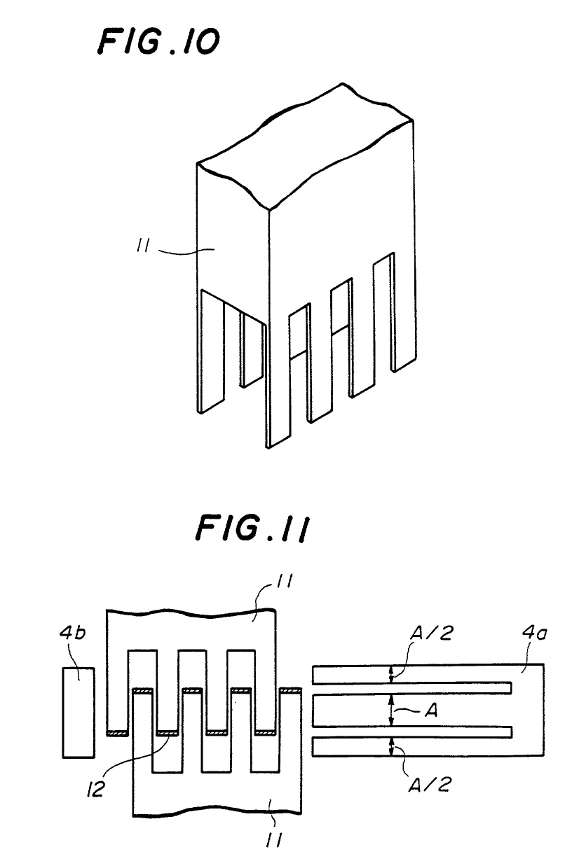

With reference to FIGS. 10 and 11, either a transformer or an inductor and a transformer or inductor manufacturing method in a third embodiment of the present invention will now be described. In manufacturing the transformer or inductor in the third embodiment, a pair of forming members 11, each of which is shown in FIG. 10 are used is jigs. The transformer or inductor in the third embodiment uses a folded patterned foil member 12 such as, for example, the folded patterned foil member 10 shown in FIG. 2. Then, similarly to the above-described coil bobbin assembly forming process of the transformer in the first embodiment, the pair of forming members 11 together sandwich and press the folded patterned foil member 12 therebetween as teeth of one member are engaged with those of the other member. Thus, a coil is formed from the folded patterned foil member 12. Then, the EI core 4a and 4b is integrated with the thus-formed coil 12 as shown in FIG. 11 similarly to the above-described process of integrating the core with the coil bobbin assembly in the first embodiment. After that, the forming members 11 may be removed from the thus-assembled coil 12 and core 4a and 4b.

As is obvious from the above-described embodiments of the present invention, in the manufacturing methods according to the present invention, a folded patterned foil member can be easily formed. Further, a coil can also be very easily formed from the folded patterned foil member simply as a result of the folded patterned foil member being sandwiched and pressed by forming members. Then, after integrating the thus-formed coil with a core, a transformer or an inductor can be thus easily formed. Thus, neither tool such as a wire winding machine is required, nor troublesome and complicate manual works are required. Therefore, the transformer or inductor manufacturing methods according to the present invention are superior methods.

The present invention can also be applied to a case where a transformer or an inductor is mounted on a printed circuit board. In such a case, predetermined holes are previously formed in a printed circuit board, and forming members sandwich the printed circuit board together with a folded patterned foil member through the thus-formed predetermined holes. By applying such a method, a process in which a transformer or an inductor is mounted onto a printed circuit board can be performed at the same time as a time the transformer or inductor is formed. Such a method can also be applied to a miniature motor assembly process. Further, by applying such a method, it is easy to connect lead parts of the thus-formed and mounted transformer or inductor with other circuits on the printed circuit board.

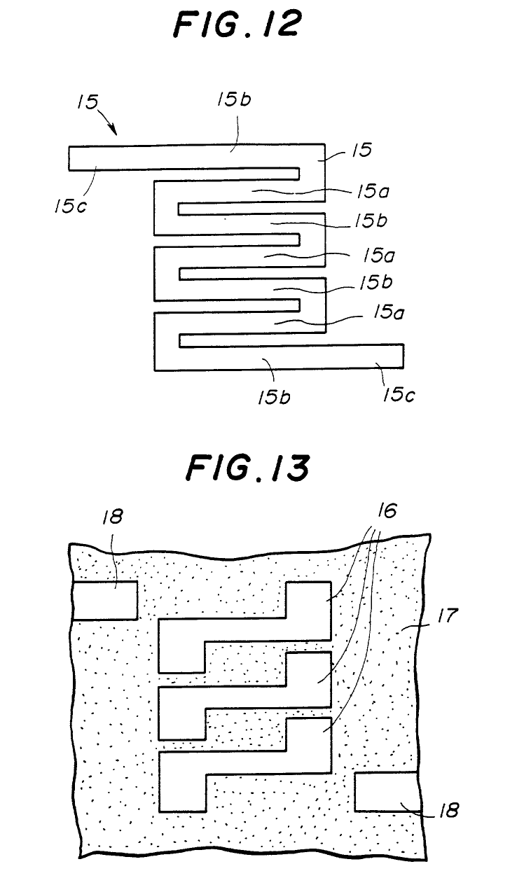

An inductor is formed and at the same time directly mounted on a printed circuit in a fourth embodiment of the present invention. An inductor and an inductor manufacturing method in the fourth embodiment of the present invention will now be described with reference to FIGS. 12 through 16. In the fourth embodiment, a folded patterned electrical conductor foil member 15, the entire surfaces thereof being electrically insulated, is used. This foil member 15 is formed as a result of, for example, an electrical conductor foil being mounted on a flexible insulated substrate such as an insulating film and then a relevant shape being stamped out from the substrate. Thus, a continuous folded pattern shown in FIG. 12 is formed in a plane. A process is performed on the thus-formed folded patterned foil member 15 such that the entire surfaces of the foil member 15 are insulated as a result of, for example, coating them with an insulating material.

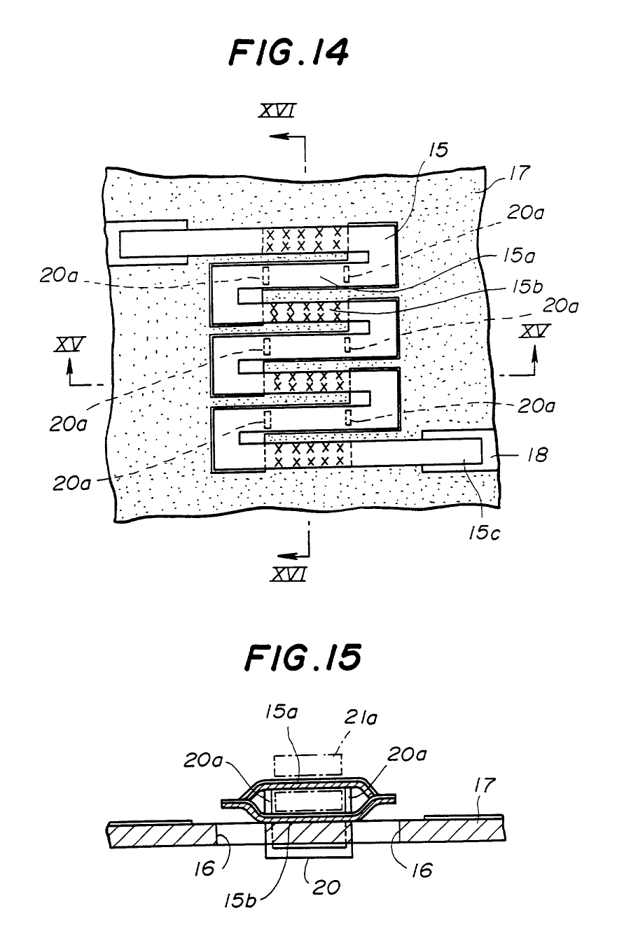

As shown in FIG. 13, three through holes 16, each having a shape like the letter Z, are formed in a printed circuit board 17. With reference to FIG. 13, a position of a horizontally extending part of each of the through holes 16 corresponds to a respective one of alternate straightly extending strip parts 15a of the foil member 15 shown in FIG. 12. Further, positions of two vertically extending parts of each of the through holes 16 correspond to a pair of bridging parts which connect two ends of a respective one of the alternate strip parts 15a to two adjacent straightly extending strip parts 15b. The bridging parts are parts extending perpendicular to the strip parts 15a. Further, as shown in FIG. 13, silver foil patterns 18 are formed on the printed circuit board 17 in positions corresponding to lead terminal parts 15c of the foil member 15 shown in FIG. 12.

Then, as shown in FIG. 14, the folded patterned foil member 15 is placed on the printed circuit board 17 according to the above-described position correspondences. As a result, each of the alternate strip parts 15a is located at a respective one of the horizontally extending parts of the through holes 16, and each of the adjacent strip parts 15b is located at a part in the printed circuit board 17 located adjacent to the through holes 16. Then, adhesive is used to bond the foil member 15 with the printed circuit board 17 so that the adjacent strip parts 15b of the foil member 15 adhere to the parts of the printed circuit board 17 located adjacent to the through holes 16. The lead terminal parts 15c of the foil member 15 are placed on the silver foil patterns 18 and bonded there later.

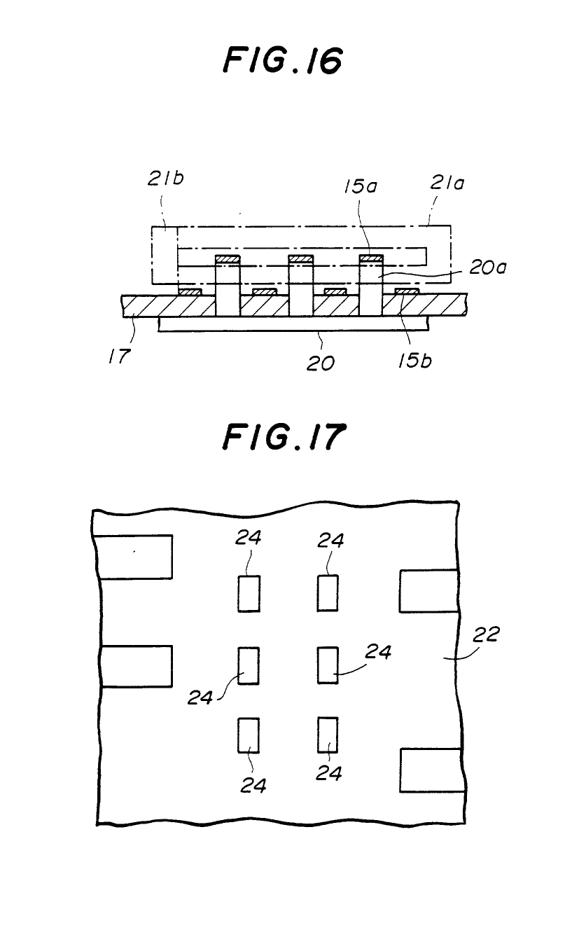

A forming member 20 is used. The forming member 20 has a plurality of comb teeth, in the embodiment shown in FIG. 14, three pairs of comb teeth 20a. As shown in FIG. 14, arrangement of the three pairs of comb teeth 20a is such that two extending ends of the comb teeth 20a of each pair of the three pairs correspond to a respective one of the alternate strip parts 15a. The forming member 20 has a cross sectional view like a squarish letter C as shown in FIG. 15. As shown in FIG. 15, each pair of the comb teeth 20a of the forming member 20 are inserted into a respective one of the through holes 16 from the bottom side of the printed circuit board 17. Then, each pair of comb teeth 20a are used to press up a respective one of the alternate strip parts 15a so that, as shown in FIG. 15, the alternate strip parts 15a are lifted while the adjacent strip parts 15b having adhered on the printed circuit board 17 as mentioned above remains on the printed circuit board 17. Thus, the foil member 15 is formed to be a coil. Then, one extending end of a body 21a of a CI core 21a and 21b is inserted into the thus-formed coil as shown in FIG. 16, and an end plate 21b is mounted onto two extending end of the body 21a. Then, the forming member 20 may be removed. Thus, the inductor consisting of the coil 15 and the core 21a and 21b is formed and is at the same time directly mounted on the printed circuit board 17. Further, the lead terminal parts 15c are bonded onto the silver foil member patterns 15 as shown in FIG. 14. Thus, according to the present invention, it is easy to form and mount an inductor onto a printed circuit board, and also handling of lead terminal parts of the inductor is easy.

As the above-described CI core (21a and 21b), various types of cores can be used, such as, for example, an air-cored core, a magnetic core, and a dielectric core.

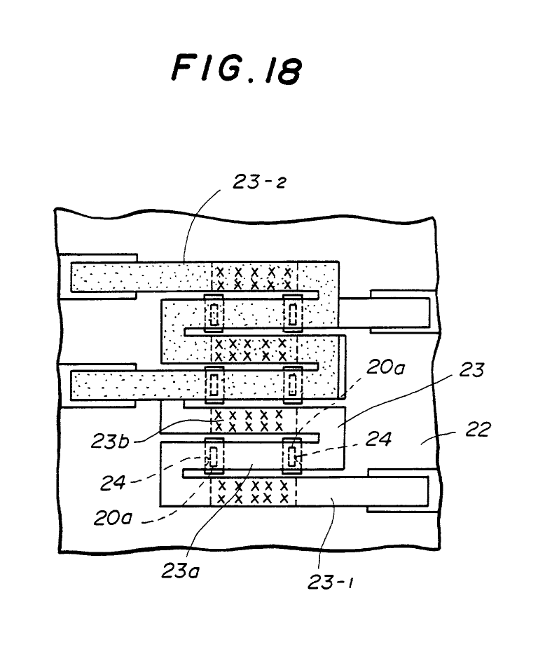

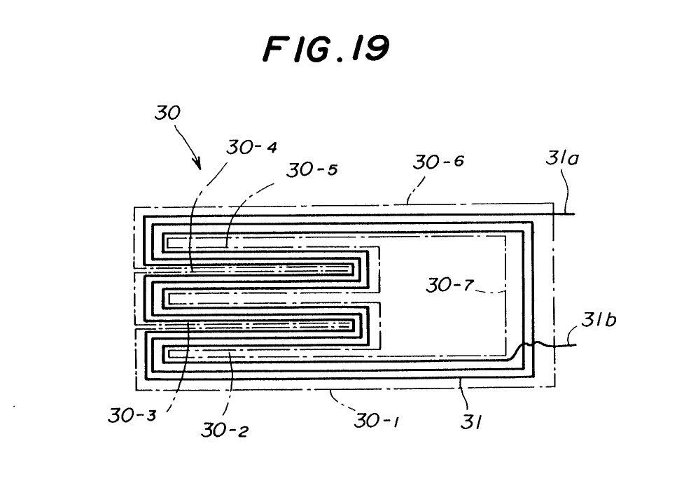

The present invention is not limited to through holes, each having a shape like the letter Z as shown in FIG. 13, formed in a printed circuit board. Any shape of such a through hole is allowed as long as comb teeth of a forming member such as the forming member 20 can be inserted into the through hole. With reference to FIGS. 17 and 18, a transformer and a transformer forming method in a fifth embodiment of the present invention will now be described. In the fifth embodiment, a printed circuit board 22 has three pairs of through holes 24 formed therein, positions of each pair of through holes 14 corresponding to a respective one of alternate straightly extending strip parts 23a of a folded patterned insulated electrical conductor foil member 23 as shown in FIG. 18. In the embodiment shown in FIG. 18, the folded patterned foil member 23 includes two layers of continuous folded pattern foil members 23₋₁ and 23₋₂ the same as the foils 1 and 2 of the foil member 10 shown in FIG. 2. Similarly to the above-described coil forming process of the fourth embodiment, the alternate strip parts 23a are lifted while adjacent straightly extending strip parts 23b having adhered on the printed circuit board 22 remains on the printed circuit board 22. Thus, the foil members 23₋₁ and 23₋₂ are formed to be coils, respectively. Thus, the transformer having two windings consisting of the foil members 23₋₁ and 23₋₂ is formed. Thus, according to the present invention, it is easy to form and mount a transformer onto a printed circuit board, and also handling of lead terminal parts of the inductor is easy.

Thus, by the present invention, it is easy to manufacture inductors and transformers which are small-sized and have light weights, and also have superior frequency characteristics. Further, transformers and inductors, and transformer or inductor manufacturing methods according to the present invention are very suitable for being manufactured in mass production and thus it is possible to greatly reduce the costs. Further, a process for mounting a transformers or an inductor onto a printed circuit board or the like, and a process for connecting lead terminal parts of a transformer or inductor to another circuit in the printed circuit board or the like can be easily performed. Thus, the present invention provides many advantages.

With reference to FIGS. 19, 20, 21A, 21B, 21C, 4, and 22, an inductor in a sixth embodiment of the present invention will now be described. The inductor uses a wiring pattern member 30 shown in FIG. 19. This wiring pattern member 30 has a folded patterned outline the same as outline of the folded patterned electrical conductor foil 1 of the foil member 10 shown in FIG. 2. For the sake of preventing the figure from being complicated, the outline of the wiring pattern member 30 is indicated using chain lines in FIG. 19.

The wiring pattern member 30 includes a row of six strip parts 30₋₁, 30₋₂, 30₋₃, 30₋₄, 30₋₅ and 30₋₆ as shown in FIG. 19. Each adjacent pair of strip parts among the six strip parts are connected with each other at the ends thereof so that the wiring pattern member 30 forms a form of a continuous series of five alternating reverse directional bends. With reference to FIG. 19, the right end of the strip part 30₋₆ is connected with the right end of the strip part 30₋₇ via a connecting part 30₋₇. Thus, the wiring pattern member 30 forms a loop including of the six strip parts and connecting part.

Further, as shown in FIG. 19, a wiring pattern of an electrical conductor foil is formed in the wiring pattern member 30. Extending of the electrical conductor foil is started at a starting end 31a from the right end of the top strip part 30₋₆. Then, the electrical conductor foil extends along the strip part 30₋₆ leftward, and then it extends downward to enter the subsequent strip part 30₋₅. Then, the electrical conductor foil extends along the strip part 30₋₅ rightward. Thus, the electrical conductor foil extends along and thus is circulated through the series of alternating reverse directional bends of the wiring pattern member 30. Then, after extending along the bottom strip part 30₋₁ rightward, the electrical conductor foil extends along the connecting part 30₋₇ upward, and then again extends along the top strip part 30₋₆. Thus, the electrical conductor foil is circulated through the above-mentioned loop including the series of alternating reverse directional bends.

Similarly, the electrical conductor foil to form the wiring pattern 31 further extends along and thus is circulated through the loop certain times. However, in the circulating through the loop certain times, a currently extending part of the electrical conductor foil does not electrically come into contact with any part of the electrical conductor foil which was extended in a previous time circulation. In the embodiment shown in FIG. 19, the electrical conductor foil extends along and thus is circulated through the loop approximately three times in total. Then, the extension of the electrical conductor foil is ended at an extending end 31b. The wiring pattern 31 shown in FIG. 19 is thus formed. The wiring pattern 31 acting as a winding of the inductor is thus obtained. The wiring pattern 31 is such that if the folded pattern of the wiring pattern member 30 is straightened, the wiring pattern 31 becomes a spiral form starting from an inner end corresponding to the end 31b and ending at an outer end corresponding to the end 31a.

The wiring pattern member 30 can be formed in a process similar to a process for forming a conventional flexible printed circuit board. Specifically, the wiring pattern 31 can be formed as a result of an appropriate mask being placed on a flexible insulating substrate. Then, the wiring pattern 31 is formed thereon in a well-known photoetching method. Then, the outline of the wiring pattern member 30 can be obtained as a result of cutting the substrate by performing a pressing processing. After that, the entire surfaces of the processed substrate are insulated by an insulating film or the like.

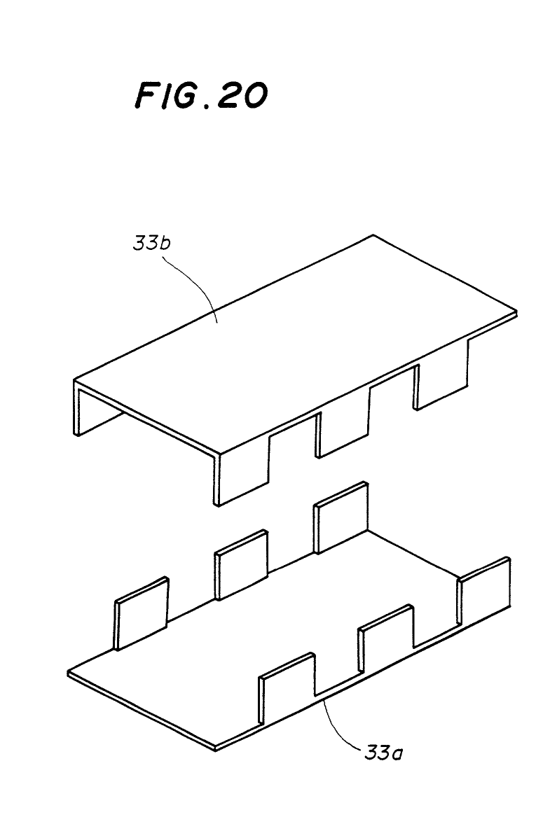

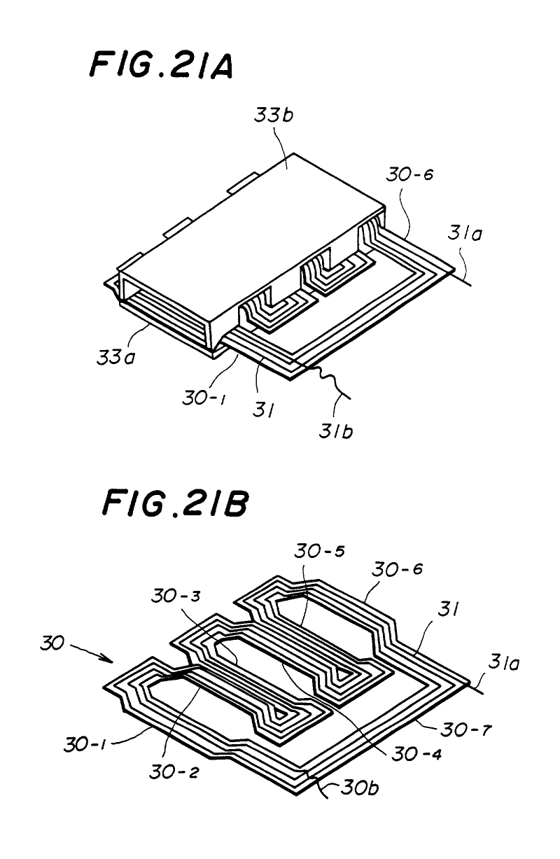

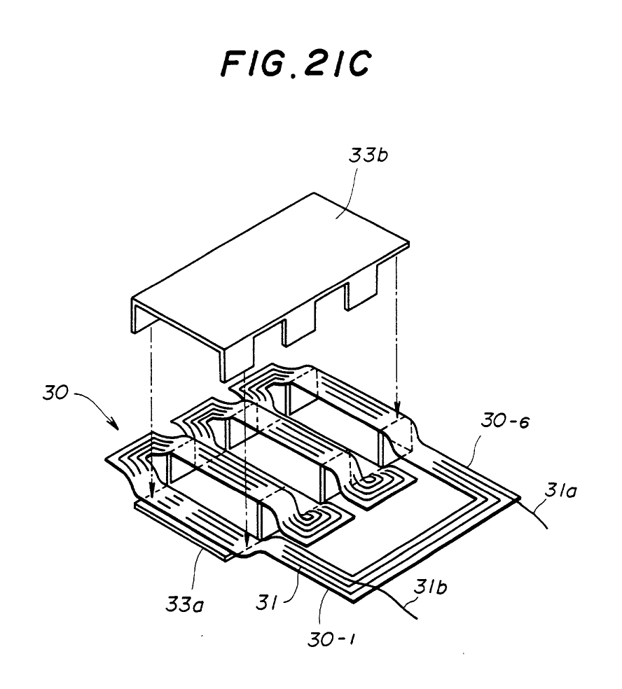

Then, the thus-formed wiring pattern member 30 is processed to form a coil of the inductor. Illustration shown in FIG. 21A serves the illustration shown in FIG. 6, and illustration shown in FIG. 21B serves the illustration shown in FIG. 7. As shown in FIG. 21B, using a pair of forming member 33a and 33b shown in FIG. 20, similarly to the above-described coil bobbin assembly forming process of the transformer in the first embodiment, the pair of forming members 33a and 33b together sandwich and press the wiring pattern member 30 therebetween as teeth of one member are engaged with those of the other member. As a result of the teeth of the forming members 33a and 33b pressing the strip parts 30₋₁ through 30₋₆, each of alternate strip parts 30₋₂, 30₋₄, and 30₋₆ is lifted and each of adjacent strip parts 30₋₁, 30₋₃, and 30₋₅ is lowered as shown in FIGS. 21B and 21C.

Thus, a coil is formed from the wiring pattern 31 of the wiring patterned member 30 as shown in FIG. 21B. In the coil shown in FIG. 21B, 3 winding turns are obtained from each one extension of the winding pattern along the entire way of the above-mentioned loop of the wiring pattern member 30. Thus, 9 winding turns can be obtained in total from the three extension of the winding pattern along the entire way of the loop. Thus, a coil bobbin assembly consisting of the coil of the wiring pattern member 30 and a bobbin of the forming members 33a and 33b is formed.

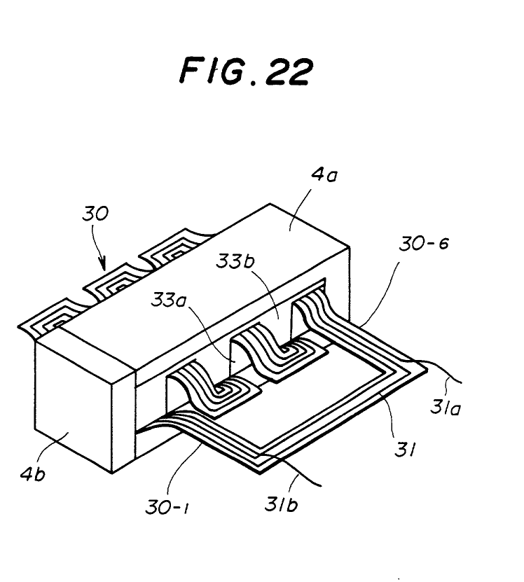

Then, similarly to a process for integrating the EI core with the coil bobbin assembly shown in FIG. 6, the EI core 4a and 4b shown in FIG. 4 is integrated with the thus-formed coil bobbin assembly as shown in FIG. 22.

The pair of forming members 33a and 33b shown in FIG. 20 are ones made of an insulating material such as a plastic and are used as the bobbin of the inductor. However, as described with reference to FIG. 8, the pair of forming members 33a and 33b may be ones made from a magnetic material such as ferrite.

According to the present invention, it is possible to effectively increase a number of winding turns in a coil of an inductor as described above for the sixth embodiment. Thus, an inductance having a high inductance can be provided.

The present invention is not limited to a use of a flexible substrate such as that mentioned above for forming a wiring pattern member such as that shown in FIG. 19. It is also possible to use a rigid substrate or a semi-rigid substrate having a shape such as that shown in FIG. 21B form forming a wiring pattern member such as that shown in FIG. 21B.

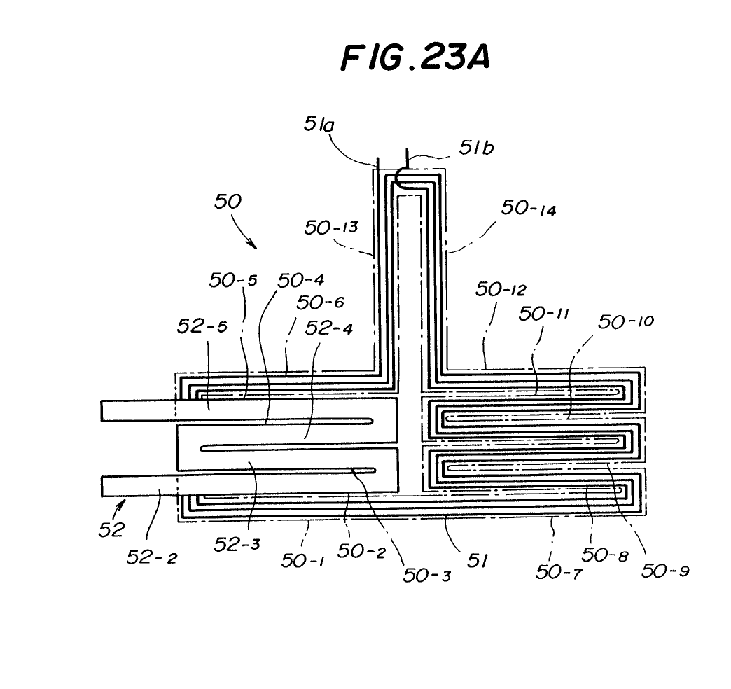

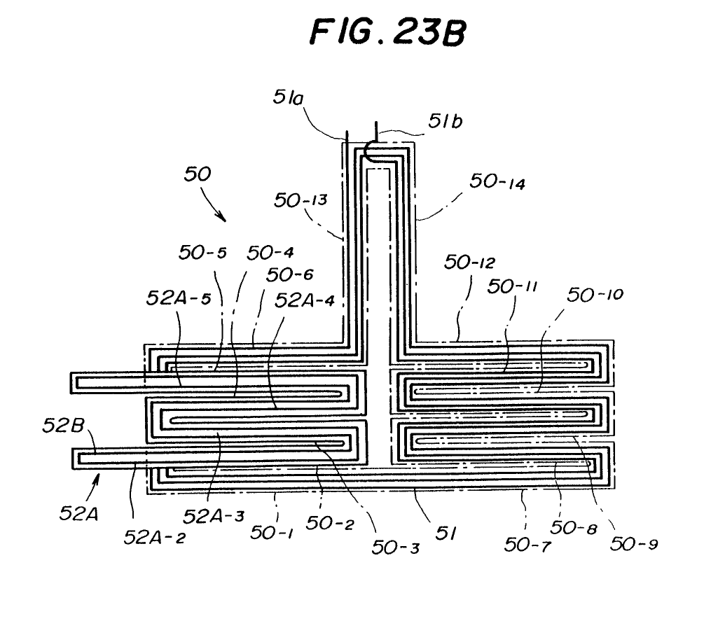

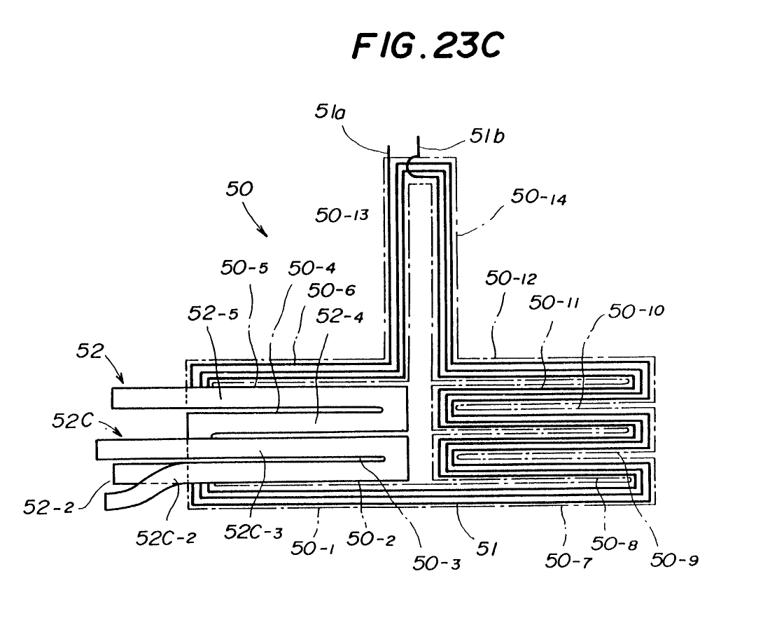

With reference to FIGS. 23A, 23B, 23C, 24, 25, 26 and 27, a transformer in a seventh embodiment of the present invention will now be described.

With reference to FIG. 23A, a wiring pattern member 50 and an electrical conductor foil member 52 will now be described. The electrical conductor foil member 52 has a folded patterned form and thus is substantially the same as the electrical conductor foil 2 of the foil member 10 shown in FIG. 2. The electrical conductor foil 52 includes four strip parts 52₋₂, 52₋₃, 52₋₄, and 52₋₅.

The wiring pattern member 50 includes 12 strip parts 50₋₁, 50₋₆, 50₋₇, 50₋₈, 50₋₈, 50₋₉, 50₋₁₀, 50₋₁₁, and 50₋₁₂. As shown in FIG. 23A, the left side 6 strip parts 50₋₁ through 50₋₆ have a folded patterned form and thus are substantially the same as the 6 strip parts 30₋₁ through 30₋₆ shown in FIG. 19. Similarly, the right 6 strip parts 50₋₇ through 50₋₁₂ also have a similar folded patterned form and thus are substantially the same as the 6 strip parts 30₋₁ through 30₋₆.

A folded patterned form consisting of the strip parts 52₋₂, 52₋₃, 52₋₄, and 52₋₅ of the electrical conductor foil 52 are the same as a folded patterned form consisting of the four strip parts 50₋₂, 50₋₃, 50₋₄, and 50₋₅ of the wiring pattern member 50. The strip parts 52₋₂, 52₋₃, 52₋₄, and 52₋₅ of the electrical conductor foil 52 are bonded onto the four strip parts 50₋₂, 50₋₃, 50₋₄, and 50₋₅ of the wiring pattern member 50. Thus, each of the strip parts 52₋₂, 52₋₃, 52₋₄, and 52₋₅ of the electrical conductor foil 52 is rightly overlapped a respective strip parts of the four strip parts 50₋₂, 50₋₃, 50₋₄, and 50₋₅ of the wiring pattern member 50. Thus, the outline of the folded patterned form of the four strip parts of the electrical conductor foil 52 overlaps the outline of the folded patterned form of the four strip parts of the wiring pattern member 50. As a result, the figures do not actually show the four strip parts 50₋₂. 50₋₃, 50₋₄, and 50₋₅.

Further, as shown in the figure, the right end of the bottom left strip part 50₋₁ is connected with the left end of the bottom right strip parts 50₋₇. Further, parallelly extending three lines of an electrical conductor foil to form a wiring pattern 31 in the strip part 50₋₁ are electrically connected with parallelly extending three lines of the electrical conductor foil in the strip part 50₋₇, respectively.

The right end of the top left strip part 50₋₆ further extends upward so as to form a lead part 50₋₁₃. Similarly, the left end of the top right strip parts 50₋₁₂ also further extends upward so as to form a lead part 50₋₁₄. Further, two lines of three lines of the electrical conductor foil in the lead part 50₋₁₃ are electrically connected with two lines of three lines of the electrical conductor foil in the lead part 50₋₁₄, respectively. A free end of the remaining one line of the electrical conductor foil in the lead part 50₋₁₃ forms a lead terminal part 51a. Similarly, a free end of the remaining one line of the electrical conductor foil in the lead part 50₋₁₄ forms a lead terminal part 51b.

Similar to the wiring pattern 31, the wiring pattern 51 is such that if the folded pattern of the wiring pattern member 50 is straightened, the wiring pattern 51 becomes a spiral form starting from an inner end corresponding to the end 51b and ending at an outer end corresponding to the end 51a.

A member to be bonded onto the pattern wiring member 50 is not limited to an electrical conductor foil such as that 52. As shown in FIG. 23B, instead of the electric conductor foil 52, it is also possible to provide another wiring pattern member 52A in which a single line of an electrical conductor foil 52B extends along a folded pattern of the wiring pattern member 52A. An outward form of the wiring pattern member 52A is the same as the electrical conductor foil 52. The wiring pattern member 52A may be formed in a manner similar to the above-described manner of forming the wiring pattern member 30 shown in FIG. 19. The wiring pattern member 52A is bonded onto the wiring pattern member 50 in a manner the same as the manner of bonding the electrical conductor foil 52 onto the wiring pattern member 50. Thus, strip parts 52A₋₂, 52A₋₃, 52A₋₄ and 52A₋₅ are bonded onto the strip parts 50₋₂, 50₋₃, 50₋₄ and 50₋₅, respectively.

Further, a number of layers to be bonded onto the pattern wiring member 50 is not limited to a single layer. It is also possible to provide a plurality of layers of members being bonded onto the wiring pattern member 50. For example, as shown in FIG. 23C, a member 52C is bonded onto the electrical conductor foil member 52 which was previously bonded onto the wiring pattern member 50. The member 52C may consist of either an electrical conductor foil member such as the electrical conductor foil member 52 or another wiring pattern member such as the wiring pattern member 52A shown in FIG. 23B. The member 52C is bonded onto the electrical conductor foil member 52 in a manner the same as the manner of bonding the electrical conductor foil member 52 onto the wiring pattern member 50. Thus, strip parts 52C₋₂ and 52C₋₃ are bonded onto the strip parts 52₋₂ and 52₋₃, respectively.

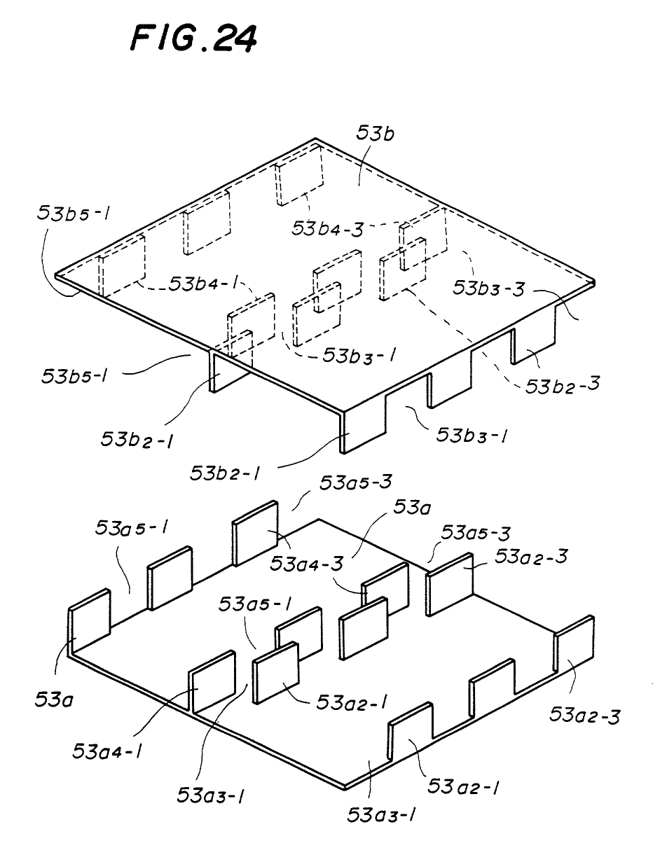

With reference to FIG. 24, a pair of forming members 53a and 53b will now be described. As shown in FIG. 24, each of the forming member 53a and 53b has 2 rows of comb teeth pairs, 53a₂₋₁ through 53a₂₋₃, , 53a₄₋₁ through 53a₄₋₃, 53b₂₋₁ through 53b₂₋₃, and 53b₄₋₁ through 53b₄₋₃, each comb tooth thereof extending toward other forming member, each row thereof including 3 comb teeth pairs. Two comb teeth of each comb teeth pair are opposed to each other. Adjacent to each comb tooth thereof, a space having a width substantially the same as a width of the comb tooth is provided. Thus, there are 2 rows of space pairs, 53a₃₋₁ through 53a₃₋₃, , 53a₅₋₁ through 53a₅₋₃, 53b₃₋₁ through 53b₃₋₃, and 53b₅₋₁ through 53b₅₋₃.

How these comb teeth pairs and spaces are arranged will now be described. In each of the forming members 53a and 53b, each comb teeth pair are aligned with a respective space pair along a direction perpendicular to a direction of each row of comb teeth pairs. For example, the comb teeth pair 53a₄₋₁ are aligned with the space pair 53a₃₋₁.

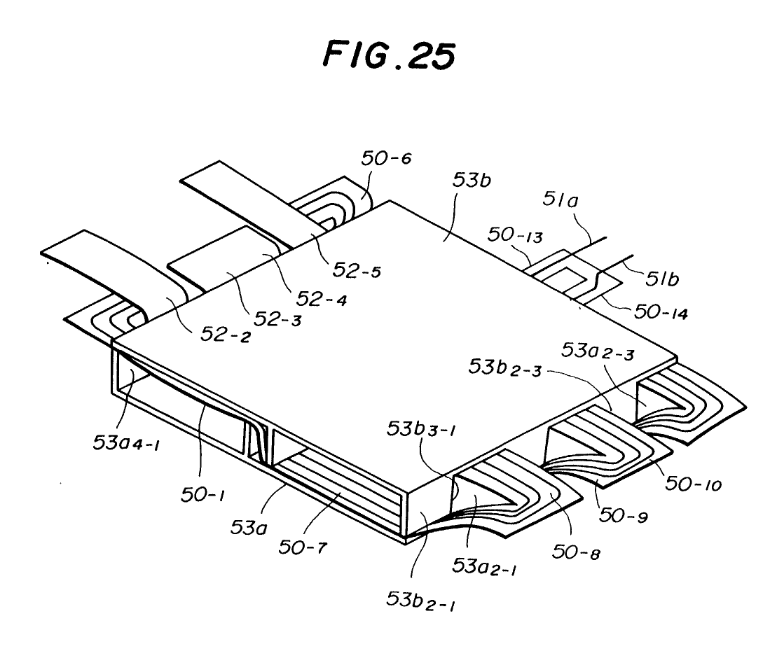

As shown in FIG. 25, an integrated body of the wiring pattern member 50 and electrical conductor foil member 52 shown in FIG. 23A is placed on the bottom forming member 53a and the top forming member 53b is pressed down onto the integrated body, appropriately. Thus, the integrated body is sandwiched by the pair of the forming members 53a and 53b and pressed therebetween. Thus, the comb teeth of the forming member 53a are engaged with those of the forming member 53b as shown in the figure.

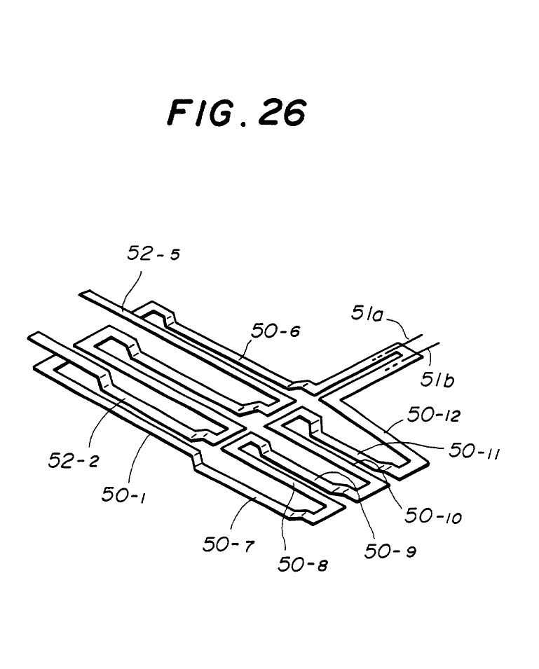

As a result, a middle part of each of alternate ones of the strip parts of the integrated body of the wiring pattern member 50 and electrical conductor foil member 52 is lowered by a respective pair of comb teeth of the pair of forming members 53a and 53b. However, a middle part of each of the remaining ones of the strip parts of the integrated body is prevented from being lowered by a respective pair of comb teeth. For example, a middle part of the strip parts 50₋₇ is lowered by the pair of comb teeth 53b₂₋₁, a middle part of the strip part 50₋₁ is prevented from being lowered by the pair of comb teeth 53a₄₋₁₁ and a middle part of an integrated strip part of the strip part 50₋₂ and the strip part 52₋₂ is lowered by the pair of comb teeth 53b₄₋₁. Thus, the integrated body of the wiring pattern member 50 and electrical conductor foil member 52 is deformed as shown in FIG. 26, and thus each adjacent pair of alternate strip part and remaining strip part forms a turn of coil in each of the wiring pattern member 50 and the electrical conductor foil member 52.

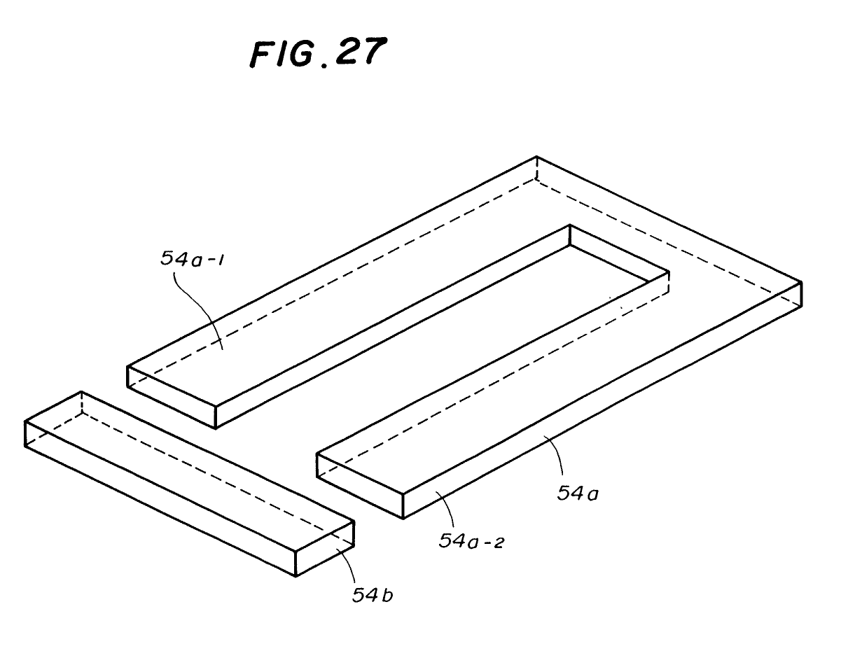

Then, a CI core 54a and 54b shown in FIG. 27 is integrated with a thus-formed coil bobbin assembly shown in FIG. 25. In the integration, an extending arms 54a₋₂ of a core body 54a is passed through a space formed between the lowered middle parts of alternate three strip parts 50₋₇, 50₋₉, 50₋₁₁ and the remaining three strip parts 50₋₈, 50₋₁₀, 50₋₁₂. Similarly, the other extending arm 54a₋₁ of the core body 54a is passed through a space formed between the lowered middle parts of the alternate three strip parts 50₋₂ (with 52₋₂), 50₋₄ (with 52₋₄), 50₋₆ and the remaining three strip parts 50₋₁, 50₋₃ (with 52₋₃), 50₋₅ (with 52₋₅). Then, a end part 54b of the core is mounted onto extending ends of the extending arms 54₋₁ and 54a₋₂ of the body 54a. Thus, the transformer in the seventh embodiment of the present invention is formed.

As the above-described CI core (54a and 54b), various types of cores can be used, such as, for example, an air-cored core, a magnetic core, and a dielectric core.

How to form a transformer using the bonded two wiring pattern members 50 and 52A shown in FIG. 23B is the same as how to form the transformer in the seventh embodiment as described above. Similarly, how to form a transformer using the bonded wiring pattern member 50, electrical conductor foil member 52, and other member 52C shown in FIG. 23C is the same as how to form the transformer in the seventh embodiment as described above.

In this transformer, a primary winding consists of the wiring pattern 51 contained in the wiring pattern member 50, and a secondary winding consists of the electrical conductor foil member 52. Each strip part of the wiring pattern member 50 has therein parallelly extending three lines of the electrical conductor foil of the wiring pattern 51. Thus, each adjacent pair of alternate strip part and remaining strip part of the wiring pattern member forms three winding turns. The wiring pattern member 50 has six adjacent pairs of alternate strip parts and remaining strip parts. Therefore, the primary winding consisting of the wiring pattern member 50 provides 18 winding turns (resulting from multiplying 6 by 3).

Further, the electrical conductor foil member 52 has two adjacent pairs of alternate strip parts and remaining strip parts. Therefore, the secondary winding consisting thereof provides 2 winding turns.

Thus, according to the present invention, it is possible to effectively greatly increase a number of winding turns by using such a wiring pattern member having a wiring pattern therein. Such an advantage that a transformer having a large winding turn number ratio can be easily obtained can be used to form a transformer used to step down a power frequency voltage into a voltage for driving a logic IC. Specifically, a transformer having a large winding turn number ratio according to the present invention can be used as a main transformer included in an AC/DC converter power source device for the same purpose. In such an application, it is required that a voltage of 141 volts is stepped down into a voltage of 5 or 3 volts. For this purpose, a transformer having a winding turn number ratio of 141/5 or 141/3 is required.

According to the present invention, a transformer having a large winding turn number ratio can be provided in low costs. Thus, an inexpensive power source device can be provided.

Thus, in the present invention, it is easy to form an insulated wiring pattern member having a folded patterned form, each strip part of the form having a plurality of parallelly extending lines of electrical conductor foil extending therein. An insulated electrical conductor foil member, acting a second winding, having a folded patterned form may be bonded onto the wiring pattern member acting as a first winding. Further, either the single wiring pattern member or an integrated body of the wiring pattern member of the first winding and folded electrical conductor foil member of the second winding may be easily deformed appropriately to have a form of a coil. The deformation may be easily performed as a result of pressing the single wiring pattern member of the integrated body between a pair of forming members. As a result, either a coil or coils having a number of winding turns either corresponding to a number of times of folding back in the folded pattern or corresponding to a number obtained as a result of multiplying the number of times of folding back by a number of parallelly extending lines of electrical conductor foil extending in each strip part is obtained. Then, a core is inserted into either the coil or coils. Thus, it is possible to provide either an inductor having a large number of winding turns and/or a large inductance, or a transformer having a large winding turn number ratio, without using a conventionally used machine such as a wire winding machine, without requiring a substantial man power. Thus, either inductor or transformer manufacturing methods very suitable for mass production can be provided.

Thus, according to the present invention, it is easily to manufacture inductors or transformers which have miniature sizes, light weights, and superior frequency characteristics. Further, electromagnetic characteristics such as inductances of the inductors or transformers can be easily freely set. Further, the inductors or transformers are very suitable for mass production, and thus it is possible to greatly lower prices thereof.

Further, in a case where the inductors or transformers in the embodiments shown in FIGS. 19 through 27 are integrated with printed circuit boards or the like, as described with reference to FIGS. 13, 14, 15, 16, 17 and 18 for the other embodiments, processes for mounting them onto the printed circuit boards or the like, and processes for connecting lead terminal parts thereof to other circuits in the printed circuit boards or the like can be easily performed. Thus, the present invention provides many advantages.

Further, the present invention is not limited to the above-described embodiments, and variations and modifications may be made without departing from the scope of the present invention.

What is claimed is

1. An electric coil comprising:
alternate strip parts comprising alternate ones among a row of strip parts formed from a sheet of electrical conductor material, said row of strip parts forming a continuous electrical conductor having a form of a series of alternating reverse directional bends, a middle part of each strip part of said alternate strip parts being aligned with one another in a first line; and
remaining strip parts comprising remaining ones among said row of strip parts, a middle part of each strip part of said remaining strip parts being aligned with one another in a second line separated from said first line.

2. The electric coil according to claim 1, further comprising a magnetic core.

3. The electric coil according to claim 1, further comprising a forming member having comb teeth, said comb teeth of said forming member being used to press and thus separate said middle part of each strip part of said alternate strip parts from said middle part of each strip part of said remaining strip parts.

4. The electric coil according to claim 3, wherein said forming member comprises a pair of forming members, comb teeth of a first one of said pair of forming members being engaged with comb teeth of a second one of said pair of forming members.

5. The electric coil according to claim 3, wherein said forming member is made of an insulating material.

6. The electric coil according to claim 3, wherein said forming member is made of a magnetic material.

7. An electric coil comprising:
an insulating sheet bent to form a form of coil; and
a wiring pattern formed in said insulating sheet.

8. The electric coil according to claim 7, further comprising a magnetic core.

9. An electric coil comprising:
alternate strip parts comprising alternate ones among a row of strip parts, a middle part of each strip part of said alternate strip parts being aligned with one another in a first line; and
remaining strip parts comprising remaining ones among said row of strip parts, a middle part of each strip part of said remaining strip parts being aligned with one another in a second line separated from said first line;
and
said row of strip parts comprising:
a substrate having a form of a series of alternating reverse directional bends, and
a plurality of electrical conductors parallelly extending along each of said strip parts.

10. The electric coil according to claim 9, further comprising a magnetic core.

11. An electric coil comprising:
alternate strip parts comprising alternate ones among a row of strip parts, a middle part of each strip part of said alternate strip parts being aligned with one another in a first line; and
remaining strip parts comprising remaining ones among said row of strip parts, a middle part said remaining strip parts being aligned with one another in a second line separated from said first line;
and
said row of strip parts comprising:
a substrate having a form of a series of alternating reverse directional bends, and
an electrical conductor extending along said substrate so as to circulate through said series of alternating reverse directional bends a plurality of times without electrically coming into contact with a part of said electrical conductor extended in a previous circulating time.

12. The electric coil according to claim 11, further comprising a magnetic core.

13. A circuit device comprising:
a substrate; and
an electric coil mounted on said substrate, said electric coil comprising:
alternate strip parts comprising alternate ones among a row of strip parts formed from a sheet of electrical conductor material, said row of strip parts forming a continuous electrical conductor having a form of a series of alternating reverse directional bends, a middle part of each strip part of said alternate strip parts being separated from a surface of said substrate; and
remaining strip parts comprising remaining ones among said row of strip parts, a middle part of each strip part of said remaining strip parts being bonded onto said surface of said substrate.

14. The circuit device according to claim 13, further comprising a magnetic core to be incorporated with said electric coil.

15. An inductor comprising an electric coil comprising:
alternate strip parts comprising alternate ones among a row of strip parts formed from a sheet of electrical conductor material, said row of strip parts forming a continuous electrical conductor having a form of a series of alternating reverse directional bends, a middle part of each strip part of said alternate strip parts being aligned with one another in a first line; and
remaining strip parts comprising remaining ones among said row of strip parts, a middle part of each strip part of said remaining strip parts being aligned with one another in a second line separated from said first line.

16. The inductor according to claim 15, further comprising a magnetic core.

17. A transformer comprising a plurality of coils, each coil of said plurality of coils comprising:
alternate strip parts comprising alternate ones among a row of strip parts formed from a sheet of electrical conductor material, said row of strip parts forming a continuous electrical conductor having a form of a series of alternating reverse directional bends, a middle part of each strip part of said alternate strip parts being aligned with one another in a first line; and
remaining strip parts comprising remaining ones among said row of strip parts, a middle part of each strip part of said remaining strip parts being aligned with one another in a second line separated from said first line.

18. The transformer according to claim 17, further comprising a magnetic core.

19. The transformer according to claim 17, wherein strip parts of row of strip parts of an electric coil of said plurality of electric coils are laid on strip parts of row of strip parts of another electric coil of said plurality of electric coils.

20. A transformer comprising a plurality of coils, at least one of said plurality of coils comprising:
alternate strip parts comprising alternate ones among a row of strip parts, a middle part of each strip part of said alternate strip parts being aligned with one another in a first line; and
remaining strip parts comprising remaining ones among said row of strip parts, a middle part of each strip part of said remaining strip parts being aligned with one another in a second line separated from said first line;
and
said row of strip parts comprising:
a substrate having a form of a series of alternating reverse directional bends, and
an electrical conductor extending along said substrate so as to circulate through said series of alternating reverse directional bends a plurality of times without electrically coming into contact with a part of said electrical conductor extended in a previous circulating time;
and
remaining ones of said plurality of coils each comprising:
alternate strip parts comprising alternate ones among a row of strip parts formed from a sheet of electrical conductor material, said row of strip parts forming a continuous electrical conductor having a form of a series of alternating reverse directional bends, a middle part of each strip part of said alternate strip parts being aligned with one another in a first line; and
remaining strip parts comprising remaining ones among said row of strip parts, a middle part of each strip part of said remaining strip parts being aligned with one another in a second line separated from said first line.

21. The transformer according to claim 20, further comprising a magnetic core.

22. An electric coil manufacturing method comprising steps of:
a) processing a sheet of electrical conductor material to form a form having series of alternating reverse directional bends of a continuous electrical conductor, said continuous electrical conductor thus comprising a row of strip parts; and
b) moving a middle part of each strip part of alternate strip parts among said row of strip parts so as to cause said middle part of each said alternate strip part to be separate from a middle part of each strip part of remaining strip parts among said row of strip parts.

23. The electric coil manufacturing method according to claim 22, further comprising a step c) incorporating a magnetic core with said row of strip parts.

24. The electric coil manufacturing method according to claim 22, wherein said step b) uses a forming member having comb teeth, said comb teeth of said forming member being used to press and thus separate said middle part of each strip part of said alternate strip parts from said middle part of each strip part of said remaining strip parts.

25. The electric coil manufacturing method according to claim 24, further comprising a step c) removing said forming member from said row of strip parts after said step b) has been performed.

26. The electric coil manufacturing method according to claim 22, further comprising a step d) of bonding said middle part of each said remaining strip part onto a surface of a substrate before performing said step b).

27. The electric coil manufacturing method according to claim 26, further comprising a step e) forming through holes in said substrate before said step b), said through holes being used to press said middle part of each said alternate strip parts so as to cause said middle part of each said alternate strip part to be separate from said middle part of each said remaining strip part.

28. An electric coil manufacturing method comprising steps of:
a) processing a substrate to form a form having series of alternating reverse directional bends comprising a row of strip parts;
b) extending an electrical conductor along said substrate so as to circulate it through said series of alternating reverse directional bends a plurality of times without it electrically coming into contact with a part of said electrical conductor, said part having extended in a previous circulating time;
c) moving a middle part of each strip part of alternate strip parts among said row of strip parts so as to cause said middle part of each said alternate strip part to be separate from a middle part of each strip part of remaining strip parts among said row of strip parts.

29. The electric coil manufacturing method according to claim 28, further comprising a step d) incorporating a magnetic core with said row of strip parts.

30. An inductor manufacturing method comprising steps of:
a) processing a sheet of electrical conductor material to form a form having series of alternating reverse directional bends of a continuous electrical conductor, said continuous electrical conductor thus comprising a row of strip parts; and
b) moving a middle part of each strip part of alternate strip parts among said row of strip parts so as to cause said middle part of each said alternate strip part to be separate from a middle part of each strip part of remaining strip parts among said row of strip parts.

31. The inductor manufacturing method according to claim 30, further comprising a step c) incorporating a magnetic core with said row of strip parts.

32. A transformer manufacturing method comprising steps of:
a) laying a plurality of sheets of electrical conductor material on one another so as to form layers of an electrical conductor;
a) processing said layers of an electrical conductor to form a form having series of alternating reverse directional bends of a continuous electrical conductor, said continuous electrical conductor thus comprising a row of strip parts; and
b) moving a middle part of each strip part of alternate strip parts among said row of strip parts so as to cause said middle part of each said alternate strip part to be separate from a middle part of each strip part of remaining strip parts among said row of strip parts.

33. The transformer manufacturing method according to claim 32, further comprising a step c) incorporating a magnetic core with said row of strip parts.

34. A transformer manufacturing method comprising steps of:
a) processing a substrate to form a form having series of alternating reverse directional bends comprising a row of strip parts;
b) extending an electrical conductor along said substrate so as to circulate it through said series of alternating reverse directional bends a plurality of times without it electrically coming into contact with a part of said electrical conductor, said part having been extended in a previous circulating time, thus forming a wiring pattern member;
c) processing a sheet of an electrical conductor layer to form a form having series of alternating reverse directional bends, said continuous electrical conductor thus comprising a row of strip parts;
d) laying a plurality of layers on one another, at least one of said layers comprising said wiring pattern member, remaining ones of said layers each comprising said sheet of an electrical conductor layer;
and
e) moving a middle part of each strip part of alternate strip parts among said row of strip parts of each of said layers so as to cause said middle part of each said alternate strip part to be separate from a middle part of each strip part of remaining strip parts among said row of strip parts.

35. The transformer manufacturing method according to claim 34, further comprising a step f) incorporating a magnetic core with said row of strip parts.
